(19) United States
(12) Patent Application Publication
(10) Pub. No.: US 2007/0200843 A1
(43) Pub. Date: Aug. 30, 2007

(54) Display driving integrated circuit and method of generating system clock signal using oscillator clock signal

(76) Inventors: Jong-kon Bae, Seocho-gu (KR); Won-sik Kang, Seodaemun-gu (KR); Jae-hyuck Woo, Osan-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/710,913

(22) Filed: Feb. 27, 2007

(30) Foreign Application Priority Data
Feb. 28, 2006 (KR) 10-2006-0019497

(51) Int. Cl. G09G 5/00

(52) U.S. Cl. 345/213

(57) ABSTRACT

A display driving circuit comprises a driving frequency output device which outputs a frame frequency of a vertical synchronization signal, a frequency of a horizontal synchronization signal, and a frequency of a PCLK signal in response to an oscillator clock signal, and a clock generator which generates a system clock signal based on the frame frequency of the vertical synchronization signal, the frequency of the horizontal synchronization signal, and the frequency of the PCLK signal, and outputs the system clock signal.

### BACKGROUND OF THE INVENTION

1. Field of the Invention

The present disclosure relates to a display driving integrated circuit which drives a display panel and, more particularly, to a display driving integrated circuit and a method of generating a system clock signal using an oscillator clock signal.

A claim of priority is made to Korean Patent Application No. 10-2006-0019497, filed Feb. 28, 2006, in the Korean Intellectual Property Office, the disclosure of which is incorporated herein in its entirety by reference.

2. Description of the Related Art

Any video device that includes a video screen also includes a display apparatus. The display apparatus is generally used to generate the images displayed on the screen. To this end, a number of conventional display apparatus are used in video devices.

FIG. 1 is a block diagram illustrating an exemplary conventional display apparatus 100. Referring to FIG. 1, the conventional display apparatus 100 includes a display panel 110, a timing controller 130, a gate driver circuit 140 (which is also called a scan line driving circuit), a source driver circuit 150 (which is also called a data line driving circuit), and a processor 170.

The timing controller 130 includes a memory 131, and outputs control signals for controlling the operation timing of the gate driver circuit 140 and the source driver circuit 150. In addition, the memory 131 stores display data and outputs the display data (or image data) to the source driver circuit 150 under the control of the timing controller 130. In addition to controlling the gate driver circuit 140 and the source driver 150, the timing controller 130 receives various display data and control signals that are output from the processor 170 via an interface 160. Upon receiving this data and signals, the controller 130 updates the display data stored in the memory 131.

The gate driver circuit 140 includes a plurality of gate drivers (not shown). These gate drivers continuously drive scan lines G1 through GM of the display panel 110 based on control signals outputted from the timing controller 130. The source driver circuit 150 includes a plurality of source drivers (not shown). These source drivers drive data lines S1 though SN of the display panel 110 based on the display data outputted from the memory 131 and the control signals outputted from the timing controller 130.

The display panel 110 displays the display data based on signals outputted from the gate driver circuit 140 and signals outputted from the source driver circuit 150. The processor 170 may be a base band processor or a graphic processor. In particular, when the display apparatus 100 is connected to a base band processor, a CPU interface interfaces the display apparatus 100 with the base band processor. On the other hand, when the display apparatus 100 is connected to a graphic processor, an RGB interface, which is also called a video interface, interfaces the display apparatus 100 and the graphic processor.

When the RGB interface is used, the display apparatus 100 generates a system clock signal based on a vertical synchronization signal, a horizontal synchronization signal, and a PCLK signal, all of which may be received from an external source. This system clock signal may be used in controlling the display data.

However, when the frequency of the vertical synchronization signal, the horizontal synchronization signal, or the PCLK signal received from the external source changes, the frequency of the system clock signal generated in the display apparatus 100 also changes. This change in frequency may cause many problems. For example, the display quality of the display apparatus 100 may deteriorate due to changes in frequency. In addition, or alternatively, the change in frequency may cause an increase in the consumption of current.

### SUMMARY OF THE INVENTION

One aspect of the present disclosure includes a display driving circuit which drives a display panel. The display driving circuit comprises a driving frequency output device which outputs a frame frequency of a vertical synchronization signal, a frequency of a horizontal synchronization signal, and a frequency of a PCLK signal in response to an oscillator clock signal, and a clock generator which generates a system clock signal based on the frame frequency of the vertical synchronization signal, the frequency of the horizontal synchronization signal, and the frequency of the PCLK signal, and outputs the system clock signal.

Another aspect of the present disclosure includes a display driving integrated circuit which drives a display panel. The display driving integrated circuit comprises a frame frequency output device which receives an oscillator clock signal and a vertical synchronization signal and outputs a frame frequency of the vertical synchronization signal in response to the oscillator clock signal and a system clock generator which generates a system clock signal based on the vertical synchronization signal and the frame frequency, and outputs the system clock signal.

Yet another aspect of the present disclosure includes a method of generating a system clock signal of a display driving integrated circuit which drives a display panel. The method comprises receiving an oscillator clock signal and a vertical synchronization signal and outputting a frame frequency of the vertical synchronization signal in response to the oscillator clock signal and outputting the system clock signal in response to the vertical synchronization signal and the frame frequency.

Another aspect of the present disclosure includes a method of generating a system clock signal. The method comprises outputting an oscillator clock signal with a uniform frequency, outputting a frame frequency of a vertical synchronization signal, a frequency of a horizontal synchronization signal, and a frequency of a PCLK signal in response to the oscillator clock signal, and generating a system clock signal based on the frame frequency, the frequency of the horizontal synchronization signal, and the frequency of the PCLK signal and outputting the system clock signal.

### BRIEF DESCRIPTION OF THE DRAWINGS

The above and other features of the present disclosure will become more apparent by describing in detail exemplary embodiments thereof with reference to the attached drawings in which:

FIG. 1 is a block diagram illustrating a conventional display apparatus;

FIG. 2 is a block diagram illustrating a display driving integrated circuit which generates a system clock signal using an oscillator clock signal according to an exemplary disclosed embodiment;

FIG. 3A is a diagram which describes processes for measuring the frame frequency of a vertical synchronization signal and the frequency of a horizontal synchronization signal using an oscillator clock signal according to an exemplary disclosed embodiment;

FIG. 3B is a diagram which describes processes for measuring the frequency of a PCLK signal using a horizontal synchronization signal according to an exemplary disclosed embodiment;

FIG. 4 is a diagram which describes a process for generating system clock signals at various frequencies using various division ratios according to an exemplary disclosed embodiment; and

FIG. 5 is a flowchart illustrating a method of generating a system clock signal of a display driving integrated circuit according to an exemplary disclosed embodiment

### DETAILED DESCRIPTION OF EMBODIMENTS

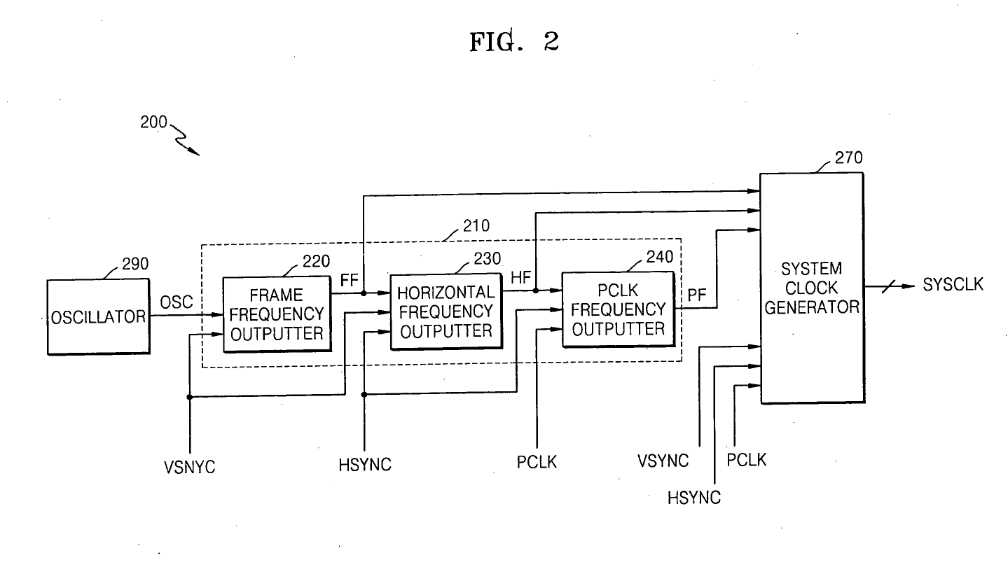

FIG. 2 is a block diagram illustrating a display driving integrated circuit 200. In an exemplary embodiment, the display driving integrated circuit 200 generates a system clock signal using an oscillator clock signal. Referring to FIG. 2, the display driving integrated circuit 200 includes a driving frequency output device 210 and a system clock generator 270. The driving frequency output 210 outputs a frame frequency FF of a vertical synchronization signal VSYNC, a frequency HF of a horizontal synchronization signal HSYNC, and a frequency PF of a PCLK signal PCLK. All of these frequencies are output in response to an oscillator clock signal OSC. The system clock generator 270 generates a system clock signal SYSCLK in response to the frame frequency FF of the vertical synchronization signal VSYNC, the frequency HF of the horizontal synchronization signal HSYNC, and the frequency PF of the PCLK signal PCLK and outputs the system clock signal SYSCLK.

In an exemplary embodiment, the driving frequency output device 210 may include a frame frequency output device 220, a horizontal frequency output device 230, and a PCLK frequency output device 240. The frame frequency output device 220 receives the oscillator clock signal OSC and the vertical synchronization signal VSYNC, and outputs the frame frequency FF of the vertical synchronization signal VSYNC in response to the oscillator clock signal OSC. Furthermore, the system clock generator 270 outputs the system clock signal SYSCLK in response to the vertical synchronization signal VSYNC and the frame frequency FF.

In an exemplary embodiment, the frame frequency output device 220 may include an oscillator clock counter (not shown). The oscillator clock counter receives the vertical synchronization signal VSYNC and the oscillator clock signal OSC, and outputs the frame frequency FF by counting the number of clock cycles of the oscillator clock signal OSC included in a clock cycle of the vertical synchronization signal VSYNC.

The horizontal frequency output device 230 outputs the frequency HF of the horizontal synchronization signal HSYNC in response to the frame frequency FF and the vertical synchronization signal VSYNC. Furthermore, the PCLK frequency output device 240 outputs the frequency PF of the PCLK signal in response to the frequency HF of the horizontal synchronization signal and the horizontal synchronization signal HSYNC.

In an exemplary embodiment, the horizontal frequency output device 230 may include a horizontal synchronization signal counter (not shown). The horizontal synchronization signal counter counts the number of clock cycles of the horizontal synchronization signal HSYNC included in a clock cycle of the vertical synchronization signal and outputs the frequency HF of the horizontal synchronization signal HSYNC by multiplying the number of clock cycles of the horizontal synchronization signal HSYNC with the frame frequency FF.

In addition, in an exemplary embodiment, the PCLK frequency output device 240 may include a PCLK signal counter (not shown). The PCLK signal counter counts the number of clock cycles of the PCLK signal PCLK included in a clock cycle of the horizontal synchronization signal HSYNC and obtains the frequency PF of the PCLK signal by multiplying the number of clock cycles of the PCLK signal PCLK with the frequency HF of the horizontal synchronization signal HSYNC, and outputs the frequency PF of the PCLK signal.

The system clock generator 270 generates the system clock signal SYSCLK using the vertical synchronization signal VSYNC, the horizontal synchronization signal HSYNC, the PCLK signal PCLK, the frame frequency FF of the vertical synchronization signal VSYNC, the frequency HF of the horizontal synchronization signal HSYNC, and the frequency PF of the PCLK signal PCLK. Furthermore, in an exemplary embodiment, the display driving integrated circuit 200 may further include an oscillator 290. The oscillator 290 outputs the oscillator clock signal OSC. In particular, the frequency of the oscillator clock signal OSC may be uniform. Moreover, the display driving integrated circuit 200 may be connected to an RGB interface.

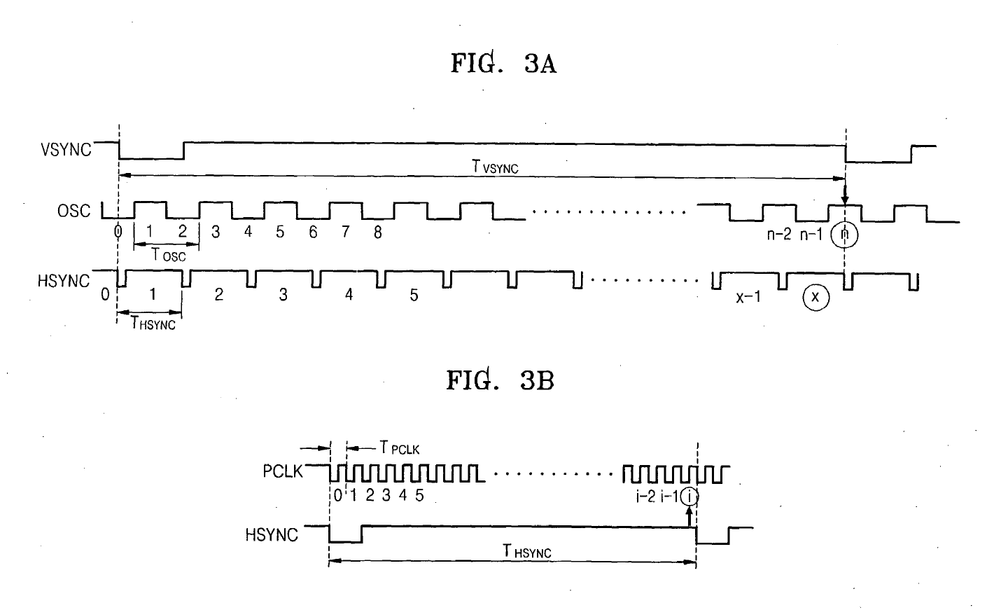

FIG. 3A is a diagram for describing processes of measuring the frame frequency FF of the vertical synchronization signal VSYNC and the frequency HF of the horizontal synchronization signal HSYNC using the oscillator clock signal OSC according to an exemplary disclosed embodiment. Furthermore, FIG. 3B is a diagram for describing a process of measuring the frequency PF of the PCLK signal PCLK using the horizontal synchronization signal HSYNC according to an exemplary disclosed embodiment. Hereinafter, operations of the display driving integrated circuit 200 according to an exemplary embodiment will be described with reference to FIGS. 2, 3A and 3B.

The frame frequency output device 220 receives the vertical synchronization signal VSYNC and the oscillator clock signal OSC. The frame frequency output device 220 then counts the number of clock cycles of the oscillator clock signal OSC that are included in one clock cycle of the vertical synchronization signal. In FIG. 3A, the number of clock cycles of the oscillator clock signal OSC is n. In this case, a period TVSYNC of the vertical synchronization signal VSYNC is 2n times a period TOSC of the oscillator clock signal OSC. Accordingly, the frame frequency FF of the vertical synchronization signal VSYNC is ½n times the frequency of the oscillator clock signal OSC.

In FIG. 3A, both a logic high period and a logic low period of the oscillator clock signal OSC are counted. Alternatively, either one of the logic high period and the logic low period of the oscillator clock signal OSC can be counted. In this case, when the number of clock cycles of the oscillator clock signal OSC is m, the frame frequency FF of the vertical synchronization signal VSYNC is 1/m times the frequency of the oscillator clock signal OSC.

The horizontal frequency output device 230 receives the horizontal synchronization signal HSYNC, the vertical synchronization signal VSYNC, and the frame frequency FF. Furthermore, the horizontal frequency output device 230 counts the number of clock cycles of the horizontal synchronization signal HSYNC included in one clock cycle of the vertical synchronization signal VSYNC. In FIG. 3A, the number of clock cycles of the horizontal synchronization signal HSYNC is x. In this case, the period YVSYNC of the vertical synchronization signal VSYNC is x times a period THSYNC of the horizontal synchronization signal HSYNC. Accordingly, the frequency HF of the horizontal synchronization signal HSYNC is x times the frame frequency FF of the vertical synchronization signal VSYNC.

The PCLK frequency output device 240 receives the PCLK signal PCLK, the horizontal synchronization signal HSYNC, and the frequency HF of the horizontal synchronization signal HSYNC. Furthermore, the PCLK frequency output device 240 counts the number of clock cycles of the PCLK signal PCLK included in one clock cycle of the horizontal synchronization signal HSYNC. In FIG. 3B, the number of clock cycles of the PCLK signal PCLK is i. In this case, the period THSYNC of the horizontal synchronization signal HSYNC is i times the period TPCLK of the PCLK signal PCLK. Accordingly, the frequency PF of the PCLK signal PCLK is i times the frequency HF of the horizontal synchronization signal HSYNC.

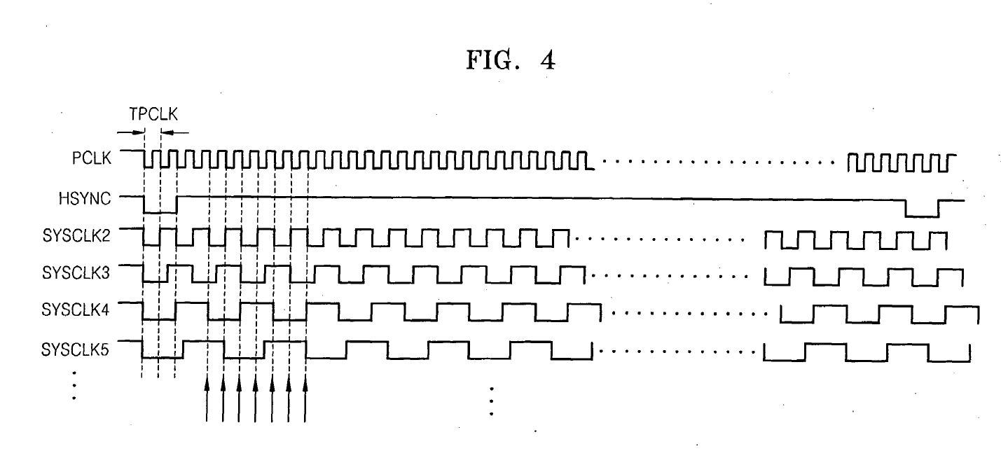

FIG. 4 is a diagram for describing a process of generating system clock signals SYSCLK2, SYSCLK3, SYSCLK 4, and SYSCLK 5 at various frequencies using various division ratios according to an exemplary disclosed embodiment. The system clock generator 270 divides the PCLK signal PCLK using various division ratios in order to generate the system clock signals SYSCLK2, SYSCLK3, SYSCLK 4, and SYSCLK 5 at various frequencies. Referring to FIG. 4, the system clock signals SYSCLK2, SYSCLK3, SYSCLK 4, and SYSCLK 5 are signals obtained by dividing the PCLK signal PCLK by division ratios 2, 3, 4, and 5, respectively.

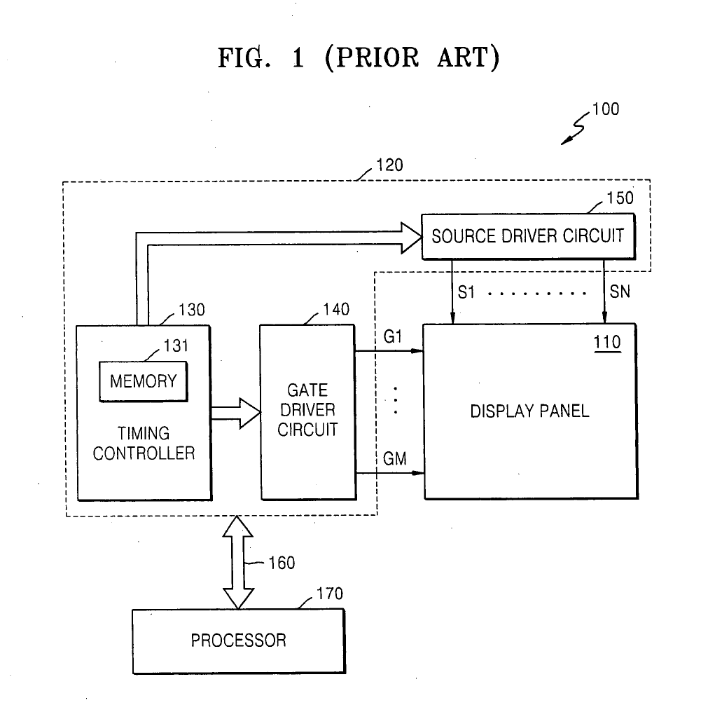

In the conventional display driving integrated circuit 100 illustrated in FIG. 1, when the frequency of the vertical synchronization signal, the horizontal synchronization signal, or the PCLK signal received from an external circuit changes, the frequency of the system clock signal also changes. However, in an exemplary disclosed embodiment, the display driving integrated circuit 200 can accurately measure the frame frequency FF of the vertical synchronization signal VSYNC, the frequency HF of the horizontal synchronization signal HSYNC, and the frequency PF of the PCLK signal PCLK using the oscillator clock signal OSC which has a uniform frequency. Accordingly, when the frequencies change, the display driving integrated circuit 200 can obtain accurate values of the frequencies. Thus, the display driving integrated circuit 200 can generate the system clock signal SYSCLK at a required frequency by applying a division ratio corresponding to the changed frequency value. In other words, even when the frame frequency FF or the like changes, the display driving integrated circuit 200 can generate the system clock signal SYSCLK at a required frequency using the oscillator clock signal OSC which has a uniform frequency.

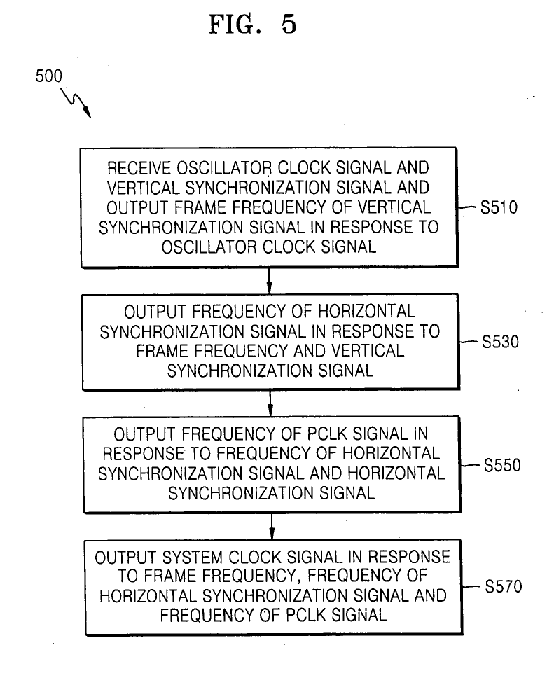

FIG. 5 is a flowchart illustrating a method 500 of generating a system clock signal of a display driving integrated circuit according to an exemplary disclosed embodiment. Generally, the method 500 comprises receiving an oscillator clock signal and a vertical synchronization signal and outputting a frame frequency of the vertical synchronization signal in response to the oscillator clock signal (operation S510), and outputting a system clock signal in response to the vertical synchronization signal and the frame frequency (operation S570).

Operation S510 may include receiving the vertical synchronization signal and the oscillator clock signal, counting the number of clock cycles of the oscillator clock signal included in a clock cycle of the vertical synchronization signal, and obtaining the frame frequency by multiplying the number of clock cycles of the oscillator clock signal and the frequency of the oscillator clock signal and outputting the frame frequency.

The method 500 may further include outputting the frequency of the horizontal synchronization signal (operation S530) and outputting the frequency of the PCLK signal (operation S550). Specifically, in operation S530, the frequency of the horizontal synchronization signal is output in response to the frame frequency and the vertical synchronization signal. In operation S550, the frequency of the PCLK signal is output in response to the frequency of the horizontal synchronization signal and the horizontal synchronization signal.

Operation S530 may include counting the number of clock cycles of the horizontal synchronization signal included in a clock of the vertical synchronization signal and obtaining the frequency of the horizontal synchronization signal by multiplying the number of clock cycles of the horizontal synchronization signal with the frame frequency, and outputting the frequency of the horizontal synchronization signal.

Operation 550 may include counting the number of clock cycles of the PCLK signal included in a clock cycle of the horizontal synchronization signal and obtaining the frequency of the PCLK signal by multiplying the number of clock cycles of the PCLK signal with the frequency of the horizontal synchronization signal, and outputting the frequency of the PCLK signal.

In operation S570, the system clock signal can be output in response to the vertical synchronization signal, the horizontal synchronization signal, the PCLK signal, the frame frequency, the frequency of the horizontal synchronization signal, and the frequency of the PCLK signal. Furthermore, in an exemplary embodiment, the oscillator clock signal can be received from an oscillator included in the display driving integrated circuit. In addition, the frequency of the oscillator clock signal may be uniform.

As described above, the display driving integrated circuit and the method of generating the system clock signal can generate a system clock signal using the oscillator clock signal, which has a uniform frequency. Accordingly, the system clock signal at a required frequency can be generated despite any change in the frame frequency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display driving integrated circuit which drives a display panel, the display driving integrated circuit comprising:
a driving frequency output device which outputs a frame frequency of a vertical synchronization signal, a frequency of a horizontal synchronization signal, and a frequency of a PCLK signal in response to an oscillator clock signal; and
a clock generator which generates a system clock signal based on the frame frequency of the vertical synchronization signal, the frequency of the horizontal synchronization signal, and the frequency of the PCLK signal, and outputs the system clock signal.

2. The display driving integrated circuit of claim 1, wherein the driving frequency output device comprises:
a frame frequency output device which receives the oscillator clock signal and the vertical synchronization signal and outputs the frame frequency of the vertical synchronization signal in response to the oscillator clock signal;
a horizontal frequency output device which outputs the frequency of the horizontal synchronization signal in response to the frame frequency and the vertical synchronization signal; and
a PCLK frequency output device which outputs the frequency of the PCLK signal in response to the frequency of the horizontal synchronization signal and the horizontal synchronization signal.

3. The display driving integrated circuit of claim 2, wherein the frame frequency output device comprises a counter which receives the vertical synchronization signal and the oscillator clock signal and outputs the frame frequency by counting a number of clock cycles of the oscillator clock signal included in a clock cycle of the vertical synchronization signal.

4. The display driving integrated circuit of claim 2, wherein the horizontal frequency output device comprises a horizontal synchronization signal counter which counts a number of clock cycles of the horizontal synchronization signal included in a clock cycle of the vertical synchronization signal and obtains the frequency of the horizontal synchronization signal by multiplying the number of counted clock cycles of the horizontal synchronization signal with the frame frequency and outputs the frequency of the horizontal synchronization signal, and
the PCLK frequency output device comprises a PCLK signal counter which counts a number of clock cycles of the PCLK signal included in a clock cycle of the horizontal synchronization signal and obtains the frequency of the PCLK signal by multiplying the number of counted clock cycles of the PCLK signal with the frequency of the horizontal synchronization signal and outputs the frequency of the PCLK signal.

5. The display driving integrated circuit of claim 1, further comprising an oscillator which outputs the oscillator clock signal.

6. The display driving integrated circuit of claim 5, wherein the frequency of the oscillator clock signal is uniform.

7. The display driving integrated circuit of claim 1, wherein the display driving integrated circuit is connected to an RGB interface.

8. A display driving integrated circuit which drives a display panel, the display driving integrated circuit comprising:
a frame frequency output device which receives an oscillator clock signal and a vertical synchronization signal and outputs a frame frequency of the vertical synchronization signal in response to the oscillator clock signal; and
a system clock generator which generates a system clock signal based on the vertical synchronization signal and the frame frequency, and outputs the system clock signal.

9. The display driving integrated circuit of claim 8, wherein the frame frequency output device comprises an oscillator clock counter which receives the vertical synchronization signal and the oscillator clock signal and outputs the frame frequency by counting a number of clock cycles of the oscillator clock signal included in a clock cycle of the vertical synchronization signal.

10. The display driving integrated circuit of claim 8, further comprising:
a horizontal frequency output device which outputs a frequency of a horizontal synchronization signal in response to the frame frequency and the vertical synchronization signal; and
a PCLK frequency output device which outputs a frequency of a PCLK signal in response to the frequency of the horizontal synchronization signal and the horizontal synchronization signal.

11. The display driving integrated circuit of claim 10, wherein the horizontal frequency output device comprises a horizontal synchronization signal counter which counts a number of clock cycles of the horizontal synchronization signal included in a clock cycle of the vertical synchronization signal and obtains the frequency of the horizontal synchronization signal by multiplying the number of counted clock cycles of the horizontal synchronization signal with the frame frequency and outputs the frequency of the horizontal synchronization signal,
the PCLK frequency output device comprises a PCLK signal counter which counts a number of clock cycles of the PCLK signal included in a clock cycle of the horizontal synchronization signal and obtains the frequency of the PCLK signal by multiplying the number of counted clock cycles of the PCLK signal with the frequency of the horizontal synchronization signal and outputs the frequency of the PCLK signal, and
the system clock generator outputs the system clock signal in response to the vertical synchronization signal, the horizontal synchronization signal, the PCLK signal, the frame frequency, the frequency of the horizontal synchronization signal, and the frequency of the PCLK signal.

12. The display driving integrated circuit of claim 8, further comprising an oscillator which outputs the oscillator clock signal.

13. The display driving integrated circuit of claim 8, wherein frequency of the oscillator clock signal is uniform.

14. A method of generating a system clock signal of a display driving integrated circuit which drives a display panel, the method comprising:
receiving an oscillator clock signal and a vertical synchronization signal and outputting a frame frequency of the vertical synchronization signal in response to the oscillator clock signal; and
outputting the system clock signal in response to the vertical synchronization signal and the frame frequency.

15. The method of claim 14, wherein the outputting the frame frequency of the vertical synchronization signal comprises:
receiving the vertical synchronization signal and the oscillator clock signal and counting a number of clock cycles of the oscillator clock signal included in a clock cycle of the vertical synchronization signal; and
obtaining the frame frequency by multiplying the number of counted clock cycles of the oscillator clock signal with a frequency of the oscillator clock signal and outputting the frame frequency.

16. The method of claim 14, further comprising:
outputting a frequency of a horizontal synchronization signal in response to the frame frequency and the vertical synchronization signal; and
outputting a frequency of a PCLK signal in response to the frequency of the horizontal synchronization signal and the horizontal synchronization signal.

17. The method of claim 16, wherein the outputting the frequency of the horizontal synchronization signal and the outputting the frequency of the PCLK signal comprises:
counting a number of clock cycles of the horizontal synchronization signal included in a clock cycle of the vertical synchronization signal; and
obtaining the frequency of the horizontal synchronization signal by multiplying the counted number of clock cycles of the horizontal synchronization signal with the frame frequency and outputting the frequency of the horizontal synchronization signal, and
counting a number of clock cycles of the PCLK signal included in a clock cycle of the horizontal synchronization signal; and
obtaining the frequency of the PCLK signal by multiplying the counted number of clock cycles of the PCLK signal with the frequency of the horizontal synchronization signal and outputting the frequency of the PCLK signal.

18. The method of claim 17, wherein the outputting the system clock signal further includes:
outputting the system clock signal in response to the vertical synchronization signal, the horizontal synchronization signal, the PCLK signal, the frame frequency, the frequency of the horizontal synchronization signal, and the frequency of the PCLK signal.

19. The method of claim 14, wherein the oscillator clock signal is received from an oscillator included in the display driving integrated circuit.

20. The method of claim 19, wherein the frequency of the oscillator clock signal is uniform.

21. The method of claim 14, wherein the display driving integrated circuit is connected to an RGB interface.

22. A method of generating a system clock signal, the method comprising:
outputting an oscillator clock signal with a uniform frequency;
outputting a frame frequency of a vertical synchronization signal, a frequency of a horizontal synchronization signal, and a frequency of a PCLK signal in response to the oscillator clock signal; and
generating a system clock signal based on the frame frequency, the frequency of the horizontal synchronization signal, and the frequency of the PCLK signal and outputting the system clock signal.
